(19) United States
(12) Patent Application Publication
(10) Pub. No.: US 2012/0297074 A1
(43) Pub. Date: Nov. 22, 2012

(54) PERFORMANCE OPTIMIZATION IN SCHEDULED TASK PERFORMANCE

(75) Inventors: Fan Mo, Ottawa (CA); Xu Chen, Ottawa (CA)

(73) Assignee: Alcatel-Lucent Canada Inc., Ottawa (CA)

(21) Appl. No.: 13/110,559

(22) Filed: May 18, 2011

(51) Int. Cl. G06F 15/16

(52) U.S. Cl. 709/227

(57) ABSTRACT

Various exemplary embodiments relate to a method and related network node including one or more of the following: determining, by the session management node, a next task time for a session; storing the next task time; waiting for a period of time; after waiting, determining whether a task should be performed with respect to the session based on the next task time; and if the task should be performed with respect to the session, sending a message to at least one other node in the subscriber network including an indication that the task should be performed with respect to the session.

### TECHNICAL FIELD

Various exemplary embodiments disclosed herein relate generally to subscription networks.

### BACKGROUND

As the demand increases for varying types of applications within mobile telecommunications networks, service providers must constantly upgrade their systems in order to reliably provide this expanded functionality. What was once a system designed simply for voice communication has grown into an all-purpose network access point, providing access to a myriad of applications including text messaging, multimedia streaming, and general Internet access. In order to support such applications, providers have built new networks on top of their existing voice networks. As seen in second and third generation networks, voice services must be carried over dedicated voice channels and directed toward a circuit-switched core, while other service communications are transmitted according to the Internet Protocol (IP) and directed toward a different, packet-switched core. This led to unique problems regarding application provision, metering and charging, and quality of experience (QoE) assurance.

In an effort to simplify the dual core approach of the second and third generations, the 3rd Generation Partnership Project (3GPP) has recommended a new network scheme it terms “Long Term Evolution” (LTE). In an LTE network, all communications are carried over an IP channel from user equipment (UE) to an all-IP core called the Evolved Packet Core (EPC). The EPC then provides gateway access to other networks while ensuring an acceptable QoE and charging a subscriber for their particular network activity.

The 3GPP generally describes the components of the EPC and their interactions with each other in a number of technical specifications. Specifically, 3GPP TS 29.212, 3GPP TS 29.213, TS 23.203, and 3GPP TS 29.214 describe the Policy and Charging Rules Function (PCRF), Policy and Charging Enforcement Function (PCEF), and Bearer Binding and Event Reporting Function (BBERF) of the EPC, These specifications also mention a Subscriber Profile Repository (SPR) that interacts with the PCEF through an Sp interface. These specifications further provide some guidance as to how these elements interact in order to provide reliable data services and charge subscribers for use thereof.

### SUMMARY

Various embodiments relate to a method performed by a session management node in a subscriber network for performing a scheduled task, the method including one or more of the following: determining, by the session management node, a next task time for a session; storing the next task time; waiting for a period of time; after waiting, determining whether a task should be performed with respect to the session based on the next task time; and if the task should be performed with respect to the session, sending a message to at least one other node in the subscriber network including an indication that the task should be performed with respect to the session.

Various embodiments relate to a session management node for performing a scheduled task in a subscriber network, the session management node including one or more of the following: an interface for communicating with at least one other network node; a task cache for storing a plurality of task records; a task scheduler configured to: determine, by the session management node, a next task time for a session, store the next task time as part of a task record stored in the task cache; a task engine configured to determine whether a task should be performed with respect to the session based on the next task record; and a message generator configured to, if the task should be performed with respect to the session, send a message via the interface to at least one other node in the subscriber network including an indication that the task should be performed with respect to the session.

Various embodiments relate to a tangible and non-transitory machine-readable storage medium encoded with instructions for execution by a session management node in a subscriber network for performing a scheduled task, the method including one or more of the following: instructions for determining, by the session management node, a next task time for a session; instructions for storing the next task time; instructions for waiting for a period of time; instructions for, after waiting, determining whether a task should be performed with respect to the session based on the next task time; and instructions for, if the task should be performed with respect to the session, sending a message to at least one other node in the subscriber network including an indication that the task should be performed with respect to the session.

Various embodiments additionally include one or more of the following: receiving, at the session management node, a session request; and performing at least one of an establishment, a modification, and a termination, with respect to the session in response to the session request; wherein the steps of determining the next task time and storing the next task time are performed in response to the step of performing at least one of an establishment, a modification, and a termination.

Various embodiments additionally include one or more of the following: applying a preconfigured rule with respect to the session, wherein the preconfigured rule is associated with a rule schedule; wherein the step of determining the next task time is performed based on the rule schedule.

Various embodiments are described wherein the step of determining a next task time includes one or more of the following: determining a rule switch time at which the preconfigured rule will no longer apply based on the rule schedule; and determining the next task time based on the rule switch time.

Various embodiments are described wherein: the step of storing the next task time includes storing the next task time and an identifier together as a task record of a plurality of task records, and the step of determining whether the task should be performed with respect to the session based on the next task time includes iterating through the plurality of task records.

Various embodiments are described wherein: the plurality of task records are stored in an ordered cache, and the step of iterating through the plurality of task records including one or more of the following: iterating through the ordered cache, locating a waiting task record of the plurality of task records for which waiting task associated with a waiting session should not yet be performed, and stopping iteration through the ordered cache in response to locating the waiting task record.

Various embodiments are described wherein the task is a reauthorization of the session.

### BRIEF DESCRIPTION OF THE DRAWINGS

In order to better understand various exemplary embodiments, reference is made to the accompanying drawings, wherein:

FIG. 1 illustrates an exemplary subscriber network for providing various data services;

FIG. 2 illustrates an exemplary session management node for scheduling tasks;

FIG. 3 illustrates an exemplary scheduled rule set;

FIG. 4 illustrates an exemplary data arrangement for storing scheduled task records;

FIG. 5 is an exemplary method for scheduling tasks; and

FIG. 6 is an exemplary method for performing scheduled tasks.

### DETAILED DESCRIPTION

While the 3GPP provides for mid-session or mid-flow changes to attributes such as charging parameters and quality of service, little guidance is provided with regard to when and where such modifications should be initiated. Service providers may wish to utilize such mid-session changes in order to effect various scheduled changes to session parameters. For example, a provider may wish to provide free nights and weekends. To effect such changes, the associated sessions and flows may be reauthorized in an exchange between the policy and charging rules node (PCRN) and packet data network gateway (PGW).

The 3GPP suggests implementing a distributed approach to scheduled reauthorizations. What guidance is provided, however, leaves much room for differences between implementations. Thus, while each equipment vendor may implement the solution suggested in 3GPP, there may be no guarantee that these various implementations are fully compatible with each other. Accordingly, there is a need for a method of predictably and consistently performing periodic or scheduled tasks, such as session reauthorization, within a subscriber network.

It should be noted that, while various examples relate to implementations of LTE, as defined by the 3GPP, the devices and methods presented herein may be applicable to other access systems or networks such as, for example, a network access system (NAS) or an online charging system (OCS). Appropriate modifications will be apparent to those of ordinary skill in the art for implementing these devices and methods in conjunction with alternative access systems and/or networks. It should also be appreciated that while various examples are described with reference to tasks associated with sessions, the methods described herein may also be applied to tasks associated with specific flows. Accordingly, as used herein, the term “session” will be understood to encompass both sessions and flows.

Referring now to the drawings, in which like numerals refer to like components or steps, there are disclosed broad aspects of various exemplary embodiments.

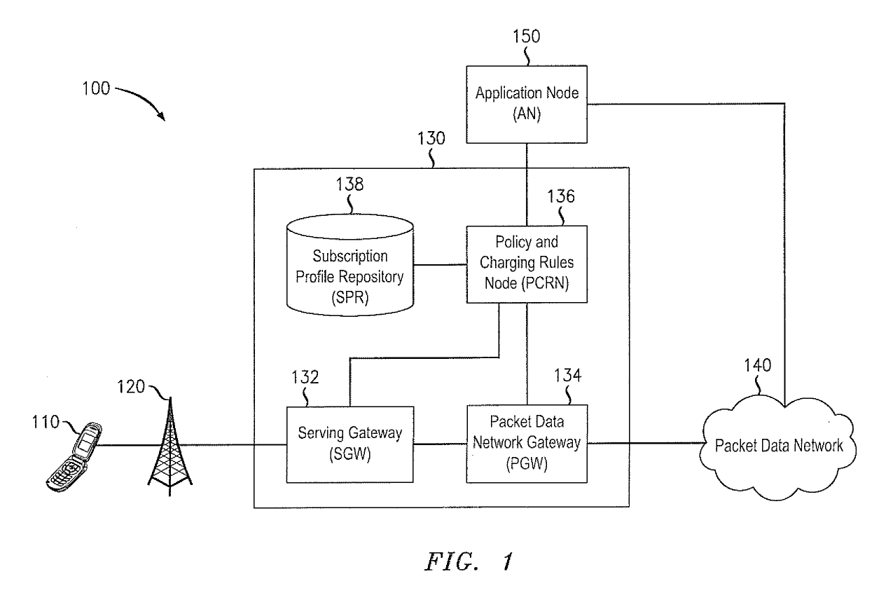

FIG. 1 illustrates an exemplary subscriber network 100 for providing various data services. Exemplary subscriber network 100 May be a telecommunications network or other network for providing access to various services. Exemplary subscriber network 100 may include user equipment (UE) 110, base station 120, evolved packet core (EPC) 130, packet data network 140, and application node (AN) 150.

User equipment 110 may be a device that communicates with packet data network 140 for providing the end-user with a data service. Such data service may include, for example, voice communication, text messaging, multimedia streaming, and Internet access. More specifically, in various exemplary embodiments, user equipment 110 is a personal or laptop computer, tablet, wireless email device, cell phone, smart phone, television set-top box, or any other device capable of communicating with other devices via EPC 130.

Base station 120 may be a device that enables communication between user equipment 110 and EPC 130. For example, base station 120 may be a base transceiver station such as an evolved nodeB (eNodeB) as defined by 3GPP standards. Thus, base station 120 may be a device that communicates with user equipment 110 via a first medium, such as radio communication, and communicates with EPC 130 via a second medium, such as Ethernet cable. Base station 120 may be in direct communication with EPC 130 or may communicate via a number of intermediate nodes (not shown). In various embodiments, multiple base stations (not shown) may be present to provide mobility to user equipment 110. Note that in various alternative embodiments, user equipment 110 may communicate directly with evolved packet core. In such embodiments, base station 120 may not be present.

Evolved packet core (EPC) 130 may be a device or network of devices that provides user equipment 110 with gateway access to packet data network 140. EPC 130 may further charge a subscriber for use of provided data services and ensure that particular quality of experience (QoE) standards are met. Thus, EPC 130 may be implemented, at least in part, according to the 3GPP TS 29.212, 29.213, and 29.214 standards. Accordingly, EPC 130 may include a serving gateway (SOW) 132, a packet data network gateway (POW) 134, a policy and charging rules node (PORN) 136, and a subscription profile repository (SPR) 138.

Serving gateway (SGW) 132 may be a device that provides gateway access to the EPC 130. SGW 132 may be the first device within the EPC 130 that receives packets sent by user equipment 110 and may forward such packets toward PGW 134. SGW 132 may perform a number of additional functions such as, for example, managing mobility of user equipment 110 between multiple base stations (not shown) and enforcing particular quality of service (QoS) characteristics, such as guaranteed bit rate, for each flow being served. In various implementations, such as those implementing the Proxy Mobile IP (PMIP) standard, SGW 132 may include a Bearer Binding and Event Reporting Function (BBERF). In various exemplary embodiments, EPC 130 may include multiple SGWs (not shown) and each SGW may communicate with multiple base stations (not shown),

Packet data network gateway (PGW) 134 may be a device that provides gateway access to packet data network 140. POW 134 may be the final device within the EPC 130 that receives packets sent by user equipment 110 toward packet data network 140 via SOW 132. PGW 134 may include a policy and charging enforcement function (PCEF) that enforces policy and charging control (PCC) rules for each service data flow (SDF). Thus, PGW 134 may be a policy and charging enforcement node (PCEN). PGW 134 may include a number of additional features such as, for example, packet filtering, deep packet inspection, and subscriber charging support.

Policy and charging rules node (PCRN) 136 may be a device that receives requests for services, generates PCC rules, and provides PCC rules to the PGW 134 and/or other PCENs (not shown). PCRN 136 may also establish other types of sessions at the request of UE 110 such as, for example, IP Connectivity Access Network (IP-CAN) sessions and/or gateway control sessions. PCRN 136 may receive requests from AN 150 via an Rx interface, from SGW 132 via a Gxx interface, and/or from PGW 134 via a Gx interface. Upon receipt of a service request, PCRN 136 may generate or modify at least one PCC rule for fulfilling the service request. PCRN 136 may communicate with SPR 138 via the Sp interface, or other data query mechanisms such as Lightweight Directory Access Protocol (LDAP), when creating PCC rules. PCRN 136 may, for example, use SPR 138 to obtain subscriber service data and/or to coordinate messages from multiple sources. In view of the session management function performed by PCRN 136, PCRN 136 may be a member of a class of devices referred to as “session management nodes.”

Upon creation or modification of a PCC rule or upon request by the PGW 134, PCRN 136 may provide a PCC rule to PGW 134 via the Gx interface. In various embodiments, such as those implementing the PMIP standard for example, PCRN 136 may also generate QoS rules. Upon creation or modification of a QoS rule or upon request by the SOW 132, PCRN 136 may provide a QoS rule to SOW 132 via the Gxx interface.

Subscription profile repository (SPR) 138 may be a device that stores information related to subscribers to the subscriber network 100. Thus, SPR 138 may include a machine-readable storage medium such as read-only memory (ROM), random-access memory (RAM), magnetic disk storage media, optical storage media, flash-memory devices, and/or similar storage media. SPR 138 may be a component of PCRN 136, may constitute an independent node within EPC 130, or may be a combination of both. SPR 138 may also be distributed across a network, with some components within EPC 130 and other components connected via a network.

SPR 138 may store a subscription record for a number of subscribers. Each subscription record may include a number of subscription identifiers such as, for example, an IPv4 address, an IPv6 address, an international mobile subscriber identity (IMSI), a network access identifier (NAI), a circuit identifier, a point-to-point protocol (PPP) identifier, and a mobile subscriber ISDN (MSISDN) number. Each subscription record may additionally include subscription parameters such as, for example, subscription tier, bandwidth limits, charging parameters, subscriber priority, and subscriber service preferences.

Note that in various alternative embodiments, subscriber network 100 may include a User Data Repository (UDR) (not shown) in lieu of SPR 138. Such a UDR may include similar data to that contained in the SPR 138. Various modifications to the techniques described herein will be apparent in order to provide interoperation between PCRN 136 and a UDR.

Packet data network 140 may be any network for providing data communications between user equipment 110 and other devices connected to packet data network 140, such as AN 150. In various embodiments, packet data network 140 may include the Internet. Packet data network 140 may further provide, for example, phone and/or Internet service to various user devices in communication with packet data network 140.

Application node (AN) 150 may be a device that includes an application function (AF) and provides an application service to user equipment 110. Thus, AN 150 may be a server or other device that provides, for example, a video streaming or voice communication service to user equipment 110. When AN 150 is to begin providing application service to user equipment 110, AN 150 may generate a request message, such as an authorization and authentication request (AAR) according to the Diameter protocol, to notify the PCRN 136. This request message may include information such as an identification of the subscriber using the application service and an identification of the particular service data flows that must be established in order to provide the requested service. AN 150 may communicate such an application request to the PCRN 136 via the Rx interface.

Various services may be requested, and subsequently established, based on an AAR sent to PCRN 136 by AN 150, based on a CCR sent to the PCRN 136 by PGW 134 or SOW 132, or based on a combination thereof. For example, PCRN 136 may receive an AAR and a CCR both requesting a particular service for a particular user. Accordingly, the PCRN 136 is adapted to determine that two request messages are associated with the same session and process the messages accordingly. For example, the PCRN 136 or a Diameter Proxy Agent (not shown) may use a session binding identifier (SBI) to determine that a request message is related to a previously received request message. Thus, PCRN 136 may establish a session based on an initial request message and subsequently modify the session based on the supplemental request message.

In provisioning sessions and flows to the PGW 134, the PCRN 136 may include attributes that are time dependent or otherwise activated based on a preset schedule. For example, a service provider may wish to provide free nights and weekends. Accordingly, a session established on Saturday at noon may include a charging parameter of $0.00/min, while the same session established on Monday at noon may include a charging parameter of $0.05/min. Further, providers may wish to update already-established sessions as time passes. Continuing with the previous example, if the session established on Monday at noon continues until 7:00 pm, the PCRN 136 may update the session at the POW 134 to now use the $0.00/min charging parameter.

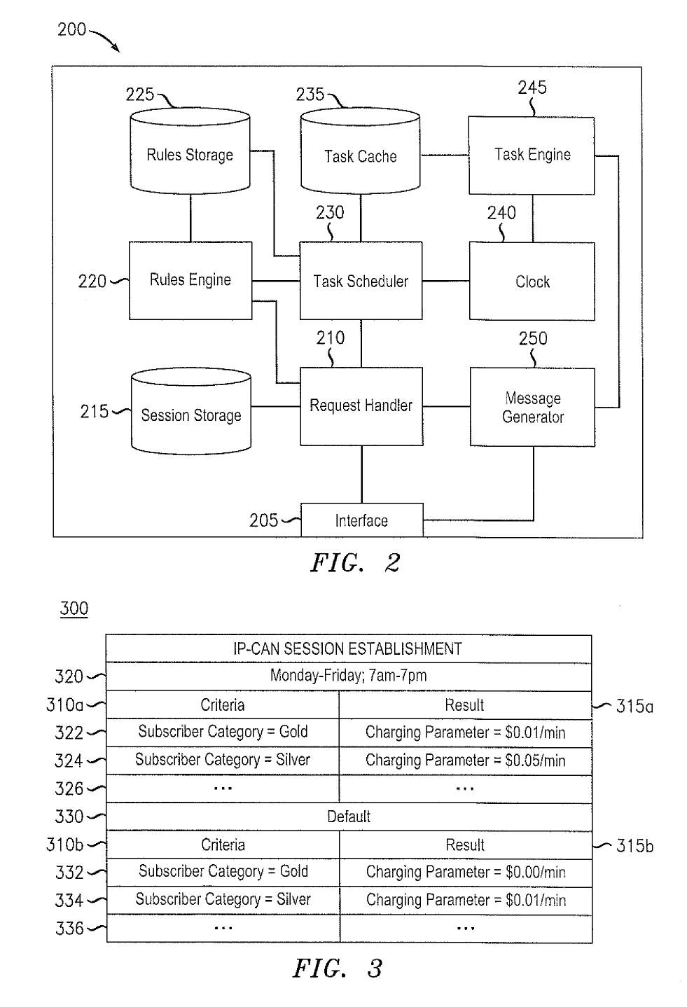

FIG. 2 illustrates an exemplary session management node 200 for scheduling tasks. In various embodiments implementing the LTE standard, session management node 200 may be a PCRN such as PCRN 136. Exemplary session management node 200 may include interface 205, request handler 210, session storage 215, rules engine 220, rules storage 225, task scheduler 230, task cache 235, clock 240, task engine 245, message generator 250.

Interface 205 may be an interface comprising hardware and/or executable instructions encoded on a machine-readable storage medium configured to communicate with other network nodes such as, for example, SOW 132, POW 134, and SPR 138. Accordingly, in various embodiments, interface 205 may communicate with various nodes using the Diameter protocol and may include a Gx, Gxx, Rx, and/or Sp interface. Further, interface 205 may include multiple physical interfaces and may enable communication over multiple networks and/or communication utilizing different protocols.

Request handler 210 may include hardware and/or executable instructions on a machine-readable storage medium configured to receive and process various messages received via interface 205. For example, request handler 210 may process any CCR, AAR, and/or RAA messages received via a Gx, Gxx, Rx, and/or Sp interface of interface 205. In various embodiments, request handler 210 may be adapted to establish, modify, and terminate flows and sessions at the request of a network node. Upon receiving such a request, request handler 210 may update data held by session storage 215 and send an indication to message generator that a response message and/or a message implementing a change should be assembled and sent to at least one node, as will be described in greater detail below with respect to message generator.

In processing various requests, request handler 210 may request a rules result from rules engine 220. For example, when establishing a new session or flow, request handler may request a charging parameter to use for the new session or flow from rules engine 210. Request handler 210 may then use the rules result in establishing, modifying, or terminating a session or flow.

Session storage 215 may be any machine-readable medium capable of storing various session and/or flow related data. For example, session storage 215 may store a number of PCC rules and/or session records. Each such item stored in session storage 215 may include an identifier, hereinafter referred to as a “session identifier,” regardless of whether the identifier is associated with a session, flow, PCC Rule, and/or any other record type associated with a service managed by session management node 200. Accordingly, session storage 215 may include a machine-readable storage medium such as read-only memory (ROM), random-access memory (RAM), magnetic disk storage media, optical storage media, flash-memory devices, and/or similar storage media.

Rules engine 220 may include hardware and/or executable instructions on a machine-readable storage medium configured to receive and fulfill requests for rules results. As such, rules engine 220 may receive requests for attribute values from request handler 210 and/or task scheduler 230. Rules engine 220 may use various context information provided by the requesting component and/or context information otherwise available to rules engine 220 to locate an applicable rule from rules storage 225. Rules engine 220 may then return the applicable rule or the values stored in the applicable rule to the requesting component.

Rules engine 220 may also be adapted to use a current time, day, and/or date as context information. As such, various rules stored in rules storage 225 may be associated with various rules schedules. For example, a rule may be applicable on weekdays, Saturdays, the first seven days of the month, and/or between 7 am and 7 pm. Additionally, various rules may be designated as default, and may apply when no other rule associated with a particular time, day, and/or date applies.

Rules storage 225 may be any machine-readable medium capable of storing rules for determining appropriate values for various attributes. As will be described in further detail below with respect to FIG. 3, each such rule may include criteria for determining whether the rule is applicable and one or more results identifying appropriate values for various attributes. Accordingly, rules storage 225 may include a machine-readable storage medium such as read-only memory (ROM), random-access memory (RAM), magnetic disk storage media, optical storage media, flash-memory devices, and/or similar storage media. In various alternative embodiments, rules storage 225 may be located in a remote device such as, for example, an SPR. Further, in various embodiments, rules and session data may be stored together on the same device. In such embodiments, session storage 215 and rules storage 225 may be the same device.

Task scheduler 230 may include hardware and/or executable instructions on a machine-readable storage medium configured to schedule tasks, such as session reauthorization, for future performance. Task scheduler 230 may receive indications from request handler 210 and/or rules engine 220 when a session is established, modified, and/or terminated and/or when a rule result is returned. In response to such indications, task scheduler 230 may store an indication in task cache 235 of a task that should be performed with respect to a session and when that task should be performed.

For example, whenever task scheduler 230 receives an indication that a rule result was returned by rules engine 220 for a particular session, task scheduler 230 may determine when the applicable rule will change by examining the rule schedule associated with the applied rule and the current time. Task scheduler 230 may then store this “task time” in association with a session identifier in task cache 235 for future use by task engine 245. In doing do, task scheduler 230 may indicate that, once the task time has passed, the associated session should be reauthorized to include the then-applicable rule result.

In various embodiments, task scheduler 230 may store various additional types of tasks in task cache for future performance. For example, task scheduler 235 may schedule inactive session cleanup and/or periodic rollovers for future performance. Accordingly, in such embodiments, task scheduler 230 may include an indication of the tack to be performed in task cache 235 along with the task time and/or session identifier. Various additional modifications for providing such functionality will be apparent to those of skill in the art.

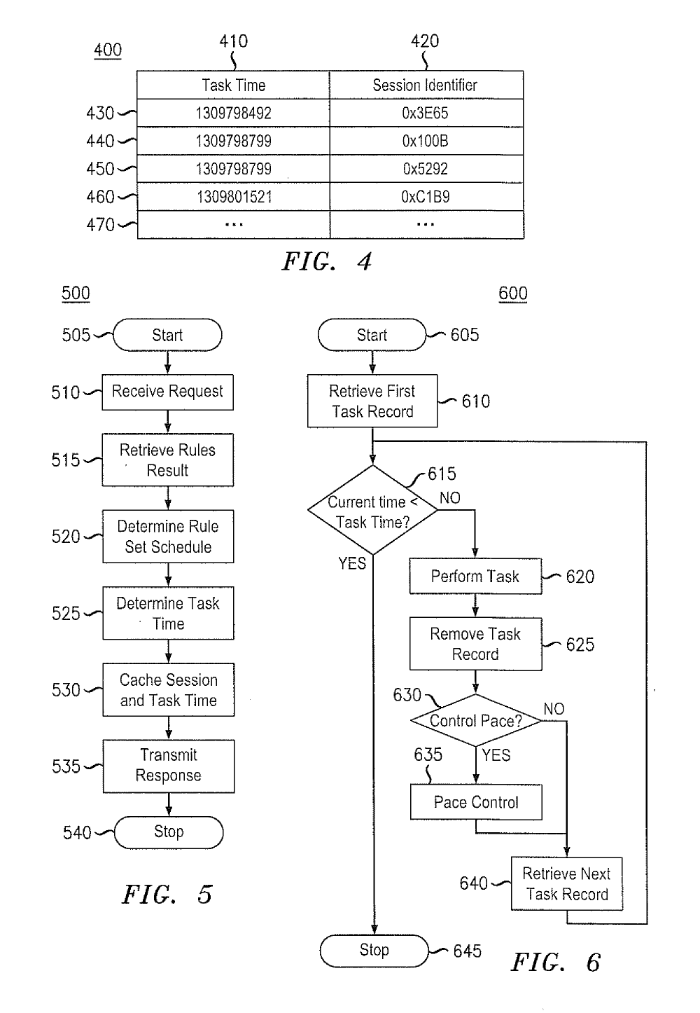

Task cache 235 may be any machine-readable medium capable of storing records of scheduled tasks. As will be described in further detail below with respect to FIG. 4, each such task record may include a time when such task is scheduled to be performed. Accordingly, task cache may include a machine-readable storage medium such as read-only memory (ROM), random-access memory (RAM), magnetic disk storage media, optical storage media, flash-memory devices, and/or similar storage media. In various embodiments, task cache 235 may be the same device as session storage 215 and/or rules storage 225. Task cache 235 may be ordered based on task time to allow for efficient location of tasks to be performed, as will be described in greater detail below with respect to FIGS. 4 and 6.

Clock 240 may include hardware and/or executable instructions on a machine-readable storage medium configured to report a current time, day, and/or date to other components upon request. In various embodiments, clock 240 may report a Unix timestamp to such requesting components. In various embodiments, clock 240 may additionally or alternatively report an amount of time elapsed since a previous event such as, for example, a previous time request or the scheduling of a task.

Task engine 245 may include hardware and/or executable instructions on a machine-readable storage medium configured to perform various tasks stored in task cache. In various embodiments, task engine 245 may periodically compare task times stored in task cache 235 to a current time reported by clock 240. For example, task engine 245 may check task cache 235 for ready tasks every hour. In various alternative embodiments, task engine 245 may constantly monitor the current time and task cache 235 and perform tasks as soon as they are ready for performance.

Upon determining that a scheduled task time has passed, task engine 245 may undertake to perform the scheduled task. For example, if a reauthorization task is to be performed, task engine may request an updated rules result from rules engine 220, update the session in session storage 215 accordingly, and indicate to message generator 250 that a message should be sent to another node to effect the reauthorization. Alternatively, task engine 245 may simply indicate to another component or node that such reauthorization should be performed.

In various embodiments wherein additional types of tasks may be scheduled and subsequently performed, task engine 245 may additionally be adapted to effect performance of such tasks. For example, task engine 245 may be configured to at least initiate an inactive session cleanup and/or a periodic rollover,

Message generator 250 may include hardware and/or executable instructions on a machine-readable storage medium configured to generate various messages for transmission to other network nodes via interface 205. In various embodiments implementing the LTE standard, message generator 250 may be adapted to construct CCA, AAA, and/or RAR messages. Upon receiving an indication from request handler 210 that a session has been established, modified, or terminated, message generator 250 may generate a message to install or remove one or more PCC rules or otherwise update a session at a different network node such as a PGW. In various embodiments, upon receiving an indication from task engine 245 that a reauthorization should be performed, message generator 250 may construct a message to install or remove one or more PCC rules or otherwise update a session or indicate that a session should be updated at a different network node such as a PGW. In various alternative embodiments wherein session management node 200 schedules other types of tasks, message generator 250 may be adapted to construct a message when appropriate informing at least one other network node that a particular task should be or has been performed.

FIG. 3 illustrates an exemplary scheduled rule set 300. Rule set 300 may be a table in a database or cache such as rules storage 225. Alternatively, rule set 300 may be a series of linked lists, an array, or a similar data structure. Thus, it should be apparent that rules set 300 is an abstraction of the underlying data; any data structure suitable for storage of this data may be used.

A session management node such as session management node 200 may have access to multiple rule sets such as rule set 300 that are to be used in different contexts. For example, rule set 300 may apply to the context of IF connectivity access network (IP-CAN) session establishment, while other rule sets (not shown) may be applicable to IP-CAN session modification and/or PCC rule creation.

Rule set 300 may include a number of fields such as criteria field 310a,b and result field 315a,b. Criteria field 310a,b may store one or more conditions that indicate, at least partially, when a rule is applicable. Result field 315a,b may store one or more result values that should be used when a rule is applicable.

Rule set 300 my further be divided into rule subsets 320, 330 that are applicable during certain times of day and/or under other conditions. Rule subsets 320, 330 may each include a number of rules that may be applicable when the corresponding rule subset is applicable. For example, rule subset 320 may be applicable on weekdays between 7:00 am and 7:00 pm. During these times, a rules engine such as rules engine 220 may attempt to apply rules 322, 324, 326 in response to a request for a relevant attribute. As a further example, rule subset 330 may be applicable when no other relevant rule subset is applicable. Thus, during weekends and between 7:00 pm and 7:00 am, may attempt to apply rules 332, 334, 336 in response to a request for a relevant attribute.

As an example, rule 322 is applicable during the day on weekdays and may apply to subscribers having a gold tier subscription. When applicable, rule 322 indicates that a charging parameter of $0.01/min should be used. As another example, rule 326 is applicable during the day on weekdays but may apply to subscribers having a silver tier subscription. When applicable, rule 324 indicates that a charging parameter of $0.05/min should be used. Rule subset 320 may include numerous additional rules 326.

As another example, rule 332 is applicable during nights and weekends and may apply to subscribers having a gold tier subscription. When applicable, rule 332 indicates that a charging parameter of $0.00/min should be used. As another example, rule 334 is applicable during nights and weekends but may apply to subscribers having a silver tier subscription. When applicable, rule 334 indicates that a charging parameter of $0.01/min should be used. Rule subset 330 may include numerous additional rules 336.

It will be appreciated that rule set 300 may be an abstraction and that, when implemented, may be arranged in an alternative manner. For example, rather than organizing rules among multiple rules subsets, schedule information may be included in a criteria field 310a,b of each rule or another schedule field (not shown) for each rule. Further, rules may be designated as belonging to multiple rules subsets. For example, an identical rule for “Subscriber Category=Bronze” may belong to both rules subsets 320, 330. Consequently, bronze tier subscriptions may include the same charging parameter regardless of day or time.

As another example of an alternative arrangement, rules set may include additional rules subsets (not shown). Further, various rules subsets may be associated with overlapping schedules. In such cases, each rules subset may be associated with a priority. When multiple subsets are active due to overlapping schedules, a rules engine may first attempt to apply the rules in the rules subset having the highest priority.

FIG. 4 illustrates an exemplary data arrangement 400 for storing scheduled task records. Data arrangement 400 may be a table in a database or cache such as task cache 235. Alternatively, data arrangement 400 may be a series of linked lists, an array, or a similar data structure. Thus, it should be apparent that data arrangement 400 is an abstraction of the underlying data; any data structure suitable for storage of this data may be used. Data arrangement 400 may include a number of fields such as task time field 410 and session identifier field 420.

Task time field 410 may store an indication of a time when a task should be run. For example, task time field 410 may store a UNIX timestamp or other indication of a specific time and/or date at which a task should be performed. Alternatively, task time 410 may store an amount of time that must elapse before the task should be performed such as, for example, a number of milliseconds that should pass prior to task performance. Various modifications to the methods and devices described herein will be apparent to enable the use of such a relative time measure.

Session identifier field 420 may store an indication of a session, flow, PCC rule, or other object managed by a session management node such as session management node 200. This indication may identify a particular session or flow that should be reauthorized when the corresponding task time is met. In various alternative embodiments wherein other types of tasks may be scheduled, data arrangement may include additional fields such s a task type field (not shown) and any other fields (not shown) helpful in defining a scheduled task for later performance.

As an example, task record 430 indicates that at time “1309798492” the object associated with identifier “0x3E65” should be reauthorized. As another example, task records 440, 450 indicate that at time “1309798799,” the objects associated with identifiers “0x100B” and “0x5292” should be reauthorized, respectively. As yet another example, task record 460 indicates that at time “1309801521” the object associated with identifier “0xC1B9” should be reauthorized. Data arrangement 400 may contain numerous additional task records 470.

In various embodiments, the task records 430, 440, 450, 460, 470 in data arrangement may be ordered. In exemplary data arrangement 400, task records 430, 440, 450, 460, 470 are ordered in ascending order based on the values stored in task time field 410. As will be apparent in the discussion below with reference to FIG. 6, such ordering may facilitate efficient location of tasks that are ready for performance.

FIG. 5 is an exemplary method 500 for scheduling tasks. Method 500 may be performed by the components of session management node 200 such as request handler 210, rules engine 220, task scheduler 230, and/or message generator 250.

Method 500 may begin in step 505 and proceed to step 510, where session management node 200 may receive a request from another node. Such request may arrive via a Gx, Gxx, Rx, or other interface. For example session management node 200 may receive a CCR over a Gx interface requesting the establishment of a new IP-CAN session. In step 515, session management node 200 may retrieve any rules results necessary or useful in fulfilling the received request. Next, in step 520, session management node 200 may determine a rule set schedule associated with the rule results. In various embodiments, session management node 200 may also determine schedules associated with other rule subsets. Such other rule schedules may be useful, for example, in various embodiments wherein rule subsets may include overlapping schedules.

In step 525, session management node 200 may determine a task time based on the rule schedule(s) determined in step 520. For example, session management node 200 may determine, based on the rule schedule, at what time and/or date the applied rule may no longer apply to the session. Once the task time is determined, session management node 200 may cache the task time along with a session identifier for future task performance in step 530. Then, in step 535, session management node 200 may transmit a response and/or other message for further processing the request received in step 510. For example, session management node 200 may send a message installing a PCC rule at a PGW. Further, the session management node 200 may transmit such messages to the node from which the request was received and/or to other nodes within the network. Method 500 may then end in step 540.

It should be apparent that method 500 is one example of a method for scheduling a task and that alternate methods may be used. For example, various steps of method 500 may be performed in an alternate order. Further, various steps may be performed in parallel as separate threads and/or processes. For example, steps 510, 515, and 535 may run as a first process while steps 520, 525, and 530 may run as a second process.

FIG. 6 is an exemplary method 600 for performing scheduled tasks. Method 600 may be performed by the components of session management node 200 such as task engine 245 and/or message generator 250. Method 600 may run periodically such as, for example, every hour. In various embodiments, for example in embodiments implementing pacing control, method 600 may run at a variable period. For example, method 600 may normally run ever hour but, while pacing control is active, may run every second.

Method 600 may begin in step 605 and proceed to step 610 where session management node 200 may retrieve a first task record from a cache. In various embodiments such as, for example, embodiments wherein the cache is ordered, session management node 200 may retrieve a task record having the lowest and/or soonest task time. In various alternative embodiments, session management node 200 may simply retrieve a random task record.

Once session management node 200 retrieves a task record, session management node 200 may determine in step 615 whether the task is ready for performance. In various embodiments, step 615 may include determining whether a current time is less than the task time. If the current time is less than the task time, session management node 200 may determine that the task associated with the current task record is not yet ready for performance. In various embodiments wherein the task cache is ordered, session management node 200 may further assume that no additional tasks are ready for performance and proceed to end in step 645. In various alternative embodiments wherein task records are not analyzed in order of task time, session management node 200 may iterate through all scheduled tasks by proceeding to step 640. It will be apparent that in such embodiments, method 600 may include a for loop or other elements operative to end method 600 once the last task record is processed.

In various embodiments wherein task times are expressed as a time interval that should pass before task performance, step 615 may instead include comparing the task time to a time that has elapsed since the last time method 600 ran. In such embodiments, method 600 may additionally include decreasing a stored task time for task records based on the time elapsed since the last time method 600 ran.

If, at step 615, session management node 200 determines that the current task should be performed, method 600 may proceed to step 620 where session management node 200 may perform the task. For example, session management node 200 may reauthorize one or more sessions associated with the task record. Step 620 may additionally or alternatively include sending one or more messages to one or more other nodes within the network indicating the performance of the task and/or indicating that the task should be performed.

Method 600 may then proceed to step 625 where session management node 200 may remove the task from the task cache. In various alternative embodiments supporting recurring tasks, method 600 may instead change the task time of the task record to the next time that the task should be performed.

Next, in step 630, session management node 200 may determine whether to employ a pacing control. For example, session management node 200 may determine that a pace should be controlled after a preset number of tasks have been performed in one execution of method 600, that the pace of task performance should be curbed. If pace should be controlled, method 600 may proceed to step 635, where session management node 200 may implement some form of pacing control. In various embodiments, session management node 200 may simply wait or put method 600 to sleep for some time before resuming operation by proceeding to step 640.

If pace should not be controlled at step 630 or if pacing control is not implemented, method 600 may proceed to step 640. In step 640, session management node 200 may retrieve a next task record to process in a manner similar to that used in step 610. Method 600 may then loop back to step 615.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method performed by a session management node in a subscriber network for performing a scheduled task, the method comprising:
determining, by the session management node, a next task time for a session;
storing the next task time;
waiting for a period of time;
after waiting, determining whether a task should be performed with respect to the session based on the next task time; and
if the task should be performed with respect to the session, sending a message to at least one other node in the subscriber network including an indication that the task should be performed with respect to the session.

2. The method of claim 1, further comprising:
receiving, at the session management node, a session request; and
performing at least one of an establishment, a modification, and a termination, with respect to the session in response to the session request;
wherein the steps of determining the next task time and storing the next task time are performed in response to the step of performing at least one of an establishment, a modification, and a termination.

3. The method of claim 1, further comprising:
applying a preconfigured rule with respect to the session, wherein the preconfigured rule is associated with a rule schedule;
wherein the step of determining the next task time is performed based on the rule schedule.

4. The method of claim 3, wherein the step of determining a next task time comprises:
determining a rule switch time at which the preconfigured rule will no longer apply based on the rule schedule; and
determining the next task time based on the rule switch time.

5. The method of claim 1, wherein:
the step of storing the next task time comprises storing the next task time and an identifier together as a task record of a plurality of task records, and
the step of determining whether the task should be performed with respect to the session based on the next task time comprises iterating through the plurality of task records.

6. The method of claim 5, wherein:
the plurality of task records are stored in an ordered cache, and
the step of iterating through the plurality of task records comprises:
iterating through the ordered cache,
locating a waiting task record of the plurality of task records for which waiting task associated with a waiting session should not yet be performed, and
stopping iteration through the ordered cache in response to locating the waiting task record.

7. The method of claim 1, wherein the task is a reauthorization of the session.

8. A session management node for performing a scheduled task in a subscriber network, the session management node comprising:
an interface for communicating with at least one other network node;
a task cache for storing a plurality of task records;
a task scheduler configured to:
determine, by the session management node, a next task time for a session,
store the next task time as part of a task record stored in the task cache;
a task engine configured to determine whether a task should be performed with respect to the session based on the next task record; and
a message generator configured to, if the task should be performed with respect to the session, send a message via the interface to at least one other node in the subscriber network including an indication that the task should be performed with respect to the session.

9. The session management node of claim 8, further comprising:
a request handler configured to:
receive, via the interface, a session request, and
perform at least one of an establishment, a modification, and a termination, with respect to the session in response to the session request;
wherein the task scheduler stores the next task time in response to the request handler performing the at least one of an establishment, a modification, and a termination.

10. The session management node of claim 8, further comprising:
a rules storage for storing a plurality of rules, each rule of the plurality of rules being associated with a rule schedule; and
a rules engine configured to apply an applied rule of the plurality of rules with respect to the session;
wherein the task scheduler is further configured to determine the next task time based on the rule schedule associated with the applied rule.

11. The session management node of claim 10, wherein, in determining the next task time, the task scheduler is configured to:
determine a rule switch time at which the applied rule will no longer apply based on the rule schedule associated with the applied rule; and
determine the next task time based on the rule switch time.

12. The session management node of claim 8, wherein:
the task cache is ordered based on a task time associated with task record of the plurality of records; and
in determining whether a task should be performed with respect to the session, the task engine is configured to:
iterate through the task cache,
locate a waiting task record of the plurality of task records for which waiting task associated with a waiting session should not yet be performed, and
stop iterating through the task cache in response to locating the waiting task record.

13. The session management node of claim 8, wherein the task is a reauthorization of the session.

14. A tangible and non-transitory machine-readable storage medium encoded with instructions for execution by a session management node in a subscriber network for performing a scheduled task, the method comprising:
instructions for determining, by the session management node, a next task time for a session;
instructions for storing the next task time;
instructions for waiting for a period of time;
instructions for, after waiting, determining whether a task should be performed with respect to the session based on the next task time; and
instructions for, if the task should be performed with respect to the session, sending a message to at least one other node in the subscriber network including an indication that the task should be performed with respect to the session.

15. The tangible and non-transitory machine-readable storage medium of claim 14, further comprising:
instructions for receiving, at the session management node, a session request; and
instructions for performing at least one of an establishment, a modification, and a termination, with respect to the session in response to the session request;
wherein the instructions for determining the next task time and storing the next task time are executed in response to the instructions for performing at least one of an establishment, a modification, and a termination.

16. The tangible and non-transitory machine-readable storage medium of claim 14, further comprising:
instructions for applying a preconfigured rule with respect to the session, wherein the preconfigured rule is associated with a rule schedule;
wherein the instructions for determining the next task time are executed based on the rule schedule.

17. The tangible and non-transitory machine-readable storage medium of claim 16, wherein the instructions for determining a next task time comprise:
instructions for determining a rule switch time at which the preconfigured rule will no longer apply based on the rule schedule; and
instructions for determining the next task time based on the rule switch time.

18. The tangible and non-transitory machine-readable storage medium of claim 14, wherein:
the instructions for storing the next task time comprise instructions for storing the next task time and an identifier together as a task record of a plurality of task records, and
the instructions for determining whether the task should be performed with respect to the session based on the next task time comprise instructions for iterating through the plurality of task records.

19. The tangible and non-transitory machine-readable storage medium of claim 18, wherein:
the plurality of task records are stored in an ordered cache, and
the instructions for iterating through the plurality of task records comprise:
instructions for iterating through the ordered cache,
instructions for locating a waiting task record of the plurality of task records for
which waiting task associated with a waiting session should not yet be performed, and
instructions for stopping iteration through the ordered cache in response to locating the waiting task record.

20. The tangible and non-transitory machine-readable storage medium of claim 14, wherein the task is a reauthorization of the session.
